(19) United States
(12) Patent Application Publication
(10) Pub. No.: US 2025/0238499 A1
(43) Pub. Date: Jul. 24, 2025

(54) Systems and Methods of Implementing Centralized Management and Active Governance for Artificial Intelligence Models

(71) Applicant: ServiceNow, Inc., Santa Clara, CA (US)

(72) Inventors: Sibanjan Debeeprasad Das, Mayurbhanj (IN); Brian Thomas Hoffman, San Diego, CA (US); Syed Mohammed Hasan Bilgrami, Aligarh (IN); Sumit Arun Deshpande, Hyderabad (IN); Kartik Kumar Sabat, Hyderabad (IN); Vijay Kotu, Hayward, CA (US)

(21) Appl. No.: 18/418,876

(22) Filed: Jan. 22, 2024

(51) Int. Cl. G06F 21/52

(52) U.S. Cl. CPC G06F 21/52

(57) ABSTRACT

A method including determining that a data quality value associated with an input to an artificial intelligence (AI) model, characterized by a plurality of features, satisfies a first threshold value. The method also includes identifying a particular feature of the plurality of features that is associated with the data quality value and determining a contribution level that indicates a relative contribution of the particular feature to an output of the AI model. Further, the method includes determining a risk score for the particular feature based on the contribution level and outputting an alert, identifying one or more models affected by the particular feature, in response to the risk score satisfying a second threshold value, wherein outputting the alert comprises outputting the alert to an external platform for display via a user interface.

### BACKGROUND

The present disclosure relates generally to collecting, organizing, maintaining, and using information about an enterprise's employees. Specifically, the present disclosure relates to developing, maintaining, and utilizing a skills ontology.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations, regardless of size, rely upon access to information technology (IT) and data and services for their continued operation and success. A respective organization's IT infrastructure may have associated hardware resources (e.g., computing devices, load balancers, firewalls, switches, etc.) and software resources (e.g., productivity software, database applications, custom applications, and so forth). Over time, more and more organizations have turned to cloud computing approaches to supplement or enhance their IT infrastructure solutions.

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, software tools, and/or other computing-based services. By doing so, users are able to access computing resources on demand that are located at remote locations and such resources may be used to perform a variety of computing functions (e.g., storing and/or processing large quantities of computing data). For enterprise and other organization users, cloud computing provides flexibility in accessing cloud computing resources such as artificial intelligence (AI) and/or data associated with implementation of AI models across the enterprise.

AI models have been incorporated by enterprises and organization users into workflows as tools to efficiently perform various workflow functions within cloud computing approaches. Within the context of creation, generation, and implementation of AI models, users may be asked to handle ever increasing amounts of training, validation and/or testing data. The amount of data collected and stored for use in AI models is typically greater than what was historically accessible to users. As such, users tasked with tracking AI model accuracy, predictive power, risk, bias, and/or value navigate ever increasing challenges to ensure AI models provide reliable outputs for implementation throughout organizational workflows. Further, due to decentralized creation and implementation of AI models across various organizational workflows, detecting deficiencies in AI models, determining how the deficiencies affect other models or features used by the enterprise, and determining the information flow of the deficiencies in the AI models is challenging.

In operating an enterprise, decisions relating to implementation of AI models may be made and actions taken based on incorrect assumptions as to which employees of the enterprise have what skills, resulting in inefficiencies in the enterprise's operations. Accordingly, it may be desirable to develop techniques for collecting and maintaining more accurate data representing skills possessed by employees of the enterprise in order to make the operations of the enterprise more efficient. It may also be desirable, to implement cloud computing based systems to establish tracking of employee actions to increase IT management efficiency of an ever-increasing number of AI models deployed across the enterprise.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

An AI governance software tool is disclosed herein that monitors AI models and provides centralized feedback to the user. The AI governance software tool provides a single platform that may include a graphical user interface (GUI) to streamline and track AI model generation, implementation, management, and changes to various AI models. In some instances, the AI governance software tool detects problems encountered by AI models, and provides alerts, service metrics, and maintenance status information related to via the GUI. In this manner, the AI governance software tool determines the priority, and/or value of the AI models. Further, the AI governance software tool creates transparency throughout the enterprise by analyzing a risk score associated with AI models based on a data quality, a feature importance, and/or a number of models impacted. Further, correction and/or removal of elements within the data set and/or AI model may be executed based on risk associated with continued implementation of a particular AI model.

The present disclosure is directed to a method including determining that a data quality value associated with an input to an artificial intelligence (AI) model, characterized by a plurality of features, satisfies a first threshold value. The method also includes identifying a particular feature of the plurality of features that is associated with the data quality value and determining a contribution level that indicates a relative contribution of the particular feature to an output of the AI model. Further, the method includes determining a risk score for the particular feature based on the contribution level and outputting an alert, identifying one or more models affected by the particular feature, in response to the risk score satisfying a second threshold value, wherein outputting the alert comprises outputting the alert to an external platform for display via a user interface.

The present disclosure is directed to a system including processing circuitry, and memory, accessible by the processing circuitry the memory storing instructions that, when executed by the processing circuitry, cause the processing circuitry to perform operations. The operations include determining that a data quality value associated with an input to an AI model, characterized by a plurality of features, satisfies a first threshold value. The operations also include identifying a particular feature of the plurality of features that is associated with the data quality value and determining a contribution level that indicates a relative contribution of the particular feature to an output of the AI model. Further the operations include determining an importance rank of the particular feature, wherein the importance rank is based on a percentage that the particular feature contributes to an output of the AI model relative to other features of the plurality of features and determining a risk impact for the particular feature, wherein the risk impact is a number of AI models, including the AI model, that use the particular feature. The operations also include determining a risk score for the particular feature based on the risk impact and the contribution level and outputting an alert in response to the risk score satisfying a second threshold value, wherein outputting the alert comprises outputting the alert to an external platform for display via a user interface, wherein the alert identifies one or more models affected by the particular feature.

The present disclosure is directed to a non-transitory computer-readable storage medium including processor-executable routines that, when executed by a processor, cause the processor to perform operations. The operations include determining that a data quality value associated with an input to an AI model satisfies a first threshold value, wherein the AI model is characterized by a plurality of features. The operations also include identifying a particular feature of the plurality of features that is associated with the data quality value, determining a contribution level that indicates a relative contribution of the particular feature to an output of the AI model and determining an importance rank of the particular feature, wherein the importance rank is based on a percentage that the particular feature contributes to an output of the AI model relative to other features of the plurality of features. Further, the operations include determining a risk impact for the particular feature, wherein the risk impact is based on a number of AI models, including the AI model, that use the particular feature and determining a risk score for the particular feature based on the risk impact and the contribution level. The operations also include outputting an alert in response to the risk score satisfying a second threshold value, wherein outputting the alert comprises outputting the alert to an external platform for display via a user interface, wherein the alert identifies one or more models affected by the particular feature.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present disclosure may operate;

FIG. 2 is a schematic diagram of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating an embodiment in which a virtual server supports and enables the client instance, in accordance with aspects of the present disclosure;

FIG. 5 is a schematic embodiment of a framework of an AI governance software tool, in accordance with aspects of the present disclosure;

FIG. 6 is schematic embodiment of a user interface of the AI governance software tool, in accordance with aspects of the present disclosure;

FIG. 7 is a schematic embodiment of the alerts widget of FIG. 6 of the AI governance software tool, in accordance with aspects of the present disclosure;

FIG. 8 is a schematic embodiment of a user interface of the AI governance software tool displayed on a screen, in accordance with aspects of the present disclosure;

FIG. 9 is a flow diagram of the AI governance software tool, in accordance with aspects of the present disclosure;

FIG. 10 is a flow diagram of the AI governance software tool, in accordance with aspects of the present disclosure;

FIG. 11 is a flow diagram of the AI governance software tool, in accordance with aspects of the present disclosure; and

FIG. 12 is a flow diagram of the AI governance software tool, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

An AI governance software tool is disclosed herein that monitors AI models, detects problems encountered by AI models, and provides alerts, service metrics, and maintenance status information related to AI models implemented across the enterprise. The AI governance software tool also provides a single platform to streamline and track AI model generation, implementation, long-term management, and retirement of models. In this manner, the AI governance software tool assesses the priority, value, and/or lifecycles of AI models and provides centralized feedback to the organizational users via the single platform. Further, the AI governance software tool creates transparency throughout the informational flow across the enterprise by providing platform as a service (PaaS) technologies to enhance execution of AI models. In particular, present embodiments include analyzing a risk score associated with AI models based on a data quality, a feature importance (e.g., the features of the model trained and/or tested by data sets), and/or a number of models impacted. Further, present embodiments enable the risk score to indicate to the user the risk associated with continued implementation of a particular AI model and/or related AI models. As such, a particular alert related to the data quality, the feature importance and/or the number of models impacted may be examined by the user. Further, correction and/or removal of elements within the data set and/or AI model may be executed. In some cases, user executed changes may be implemented across related AI models to maintain reliability of other AI models. Additionally, present embodiments include a graphical user interface (GUI) designed to present alerts, service metrics, and maintenance status for issue associated with the particular AI model and related AI models in a concise and organized format, which enables the user to more quickly and easily explore and determine a root cause and/or a solution for the particular AI model generating the particular alert.

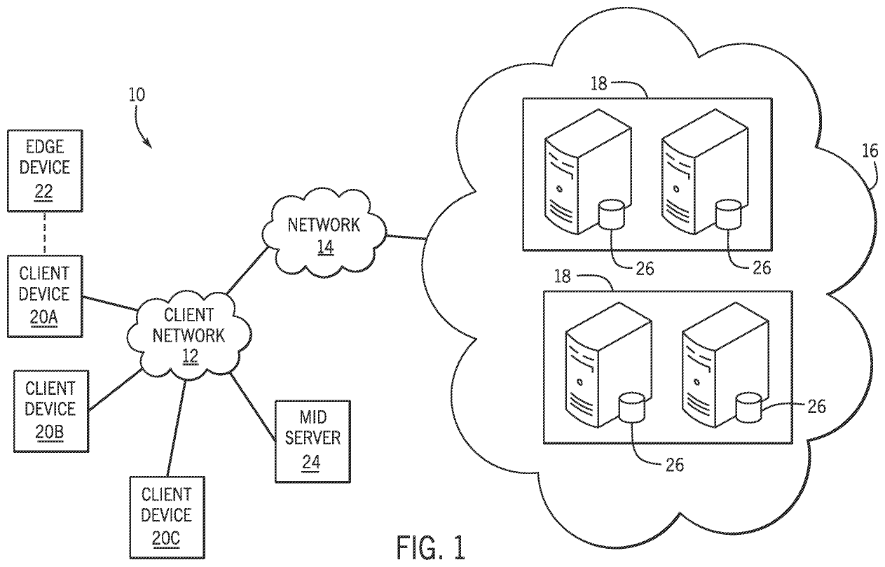

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In some implementations, the cloud-based platform 16 may be a configuration management database (CMDB) platform in which hardware, software, and/or other aspects of the client network 12 and/or cloud-based platform are regularly tracked and monitored. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial device, server, or software-implemented agent, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to as application nodes, application servers, virtual server instances, application instances, or application server instances), where one or more virtual servers 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

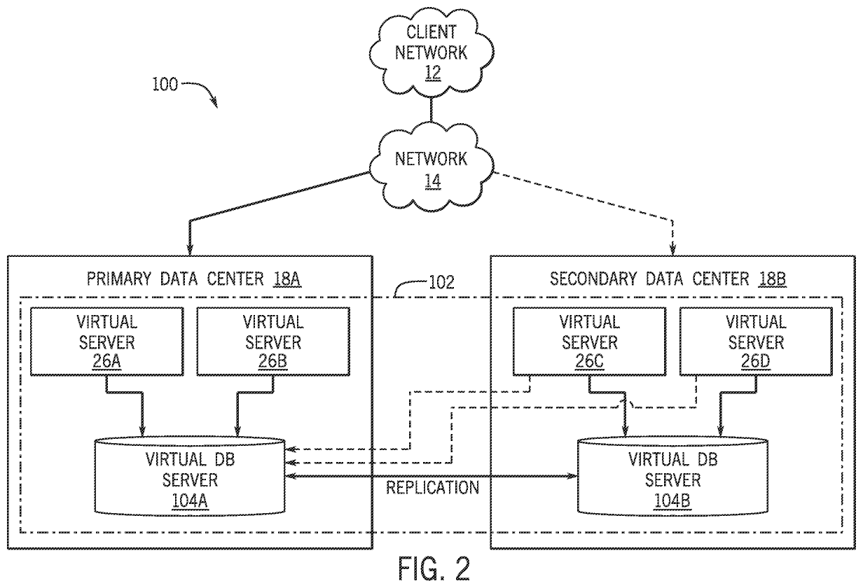

In another embodiment, one or more of the data centers 18 are configured using a multi-instance cloud architecture to provide every customer its own unique customer instance or instances. For example, a multi-instance cloud architecture could provide each customer instance with its own dedicated application server and dedicated database server. In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

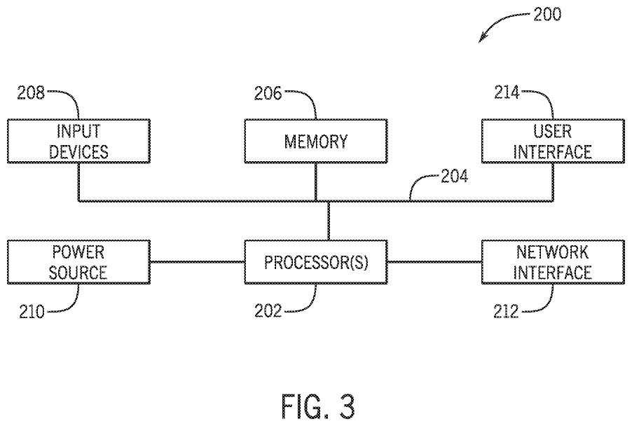

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition to and/or alternative to the display, the user interface 214 may include other devices for interfacing with a user, such as lights (e.g., LEDs), speakers, and the like.

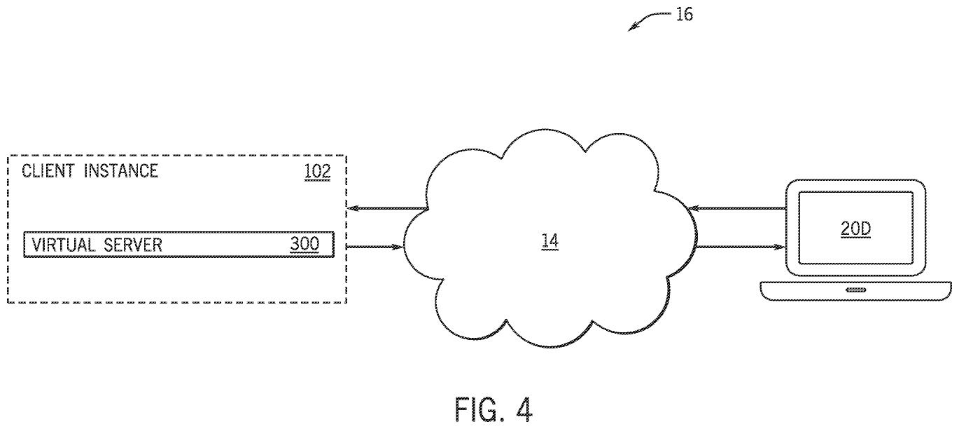

With the preceding in mind, FIG. 4 is a block diagram illustrating an embodiment in which a virtual server 300 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20D via the network 14 to provide a user interface to network applications executing within the client instance 102 (e.g., via a web browser of the client device 20D). Client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device 20D, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with client instance 102 using an application that is executed within a web browser.

Returning to FIG. 1, the cloud-based platform 16 may be used to monitor and/or manage activities performed by an enterprise or organization that operates the client network 12. Currently, there is no centralized management system to manage the lifecycle of AI models that may be implemented in such an environment (such as for client use or operations) or used in the monitoring and/or managing such an environment. This may include, for example, development of models, assessing the risk and/or value of AI models within an enterprise, auditing AI models, assessing the health of AI models, notifying users and/or stakeholders when a problem with an AI model is found, identifying other AI models and/or features that may be affected when a problem with an AI model is found, developing and implementing security workflows for managing AI models, determining when AI models should be retired or otherwise phased out, and so forth. For example, if an enterprise relies on individuals to manage the lifecycles of the AI models they use, it may be difficult for those individuals to identify risks or issues that may arise with respect to the AI models the individuals use. Further, even if a risk associated with a particular AI model is identified within a particular workflow of an enterprise, it may be difficult to identify a cause of the risk, identify other AI models or features used by the AI model that may be affected by the risk, and notify the stakeholders or users of the affected models/features. As such, even if an alteration to the affected AI model is devised and implemented by a user of the model within the particular workflow to address the determined risk relating to the model, due to the lack of centralized management, the determined risk and/or the alteration of the AI model may not be communicated to users across additional workflows, allowing the risk to persist and impact additional models and/or features. Accordingly, there is a need for centralized management and active governance of AI models to analyze accuracy, predictive power, risk, bias, and/or value.

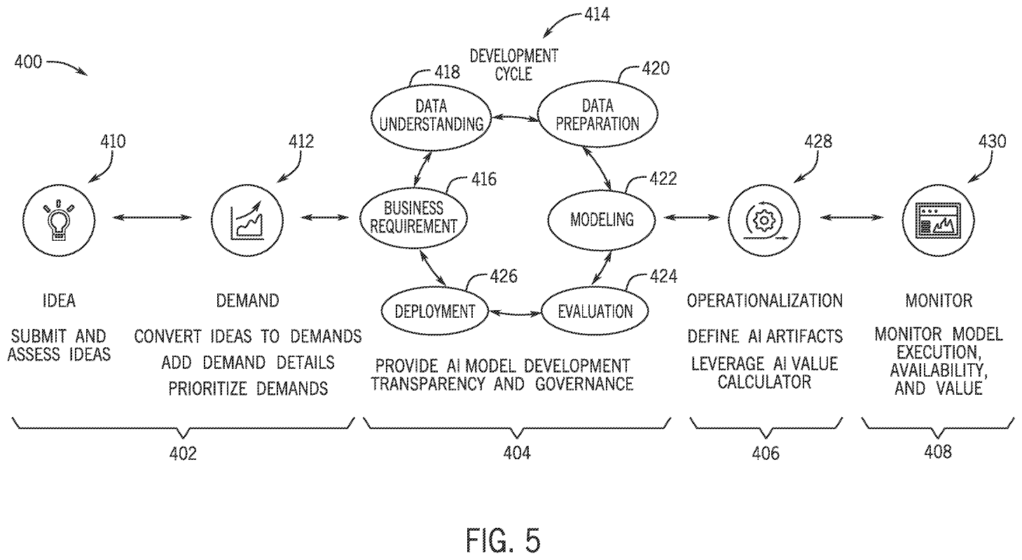

With this in mind, FIG. 5 is a schematic illustrating a framework 400 of an AI governance software tool to be utilized within an enterprise. The AI governance software tool promotes centralized management and active governance of AI models used throughout the enterprise through creation of an AI inventory record. The AI inventory record monitors, and/or tracks a plurality of AI models through various stages of the AI models' lifecycle (e.g., AI model life from development to retirement). As shown, one or more management stages may be included in the framework 400 of the AI governance software tool. It should be noted, that the illustrated management stages are provided as examples and more, fewer, or different management stages may be included in the framework 400 of the AI governance software tool. As shown, the management stages encompassed in the AI inventory record may include a generation stage 402, a development stage 404, an implementation stage 406, and a management stage 408. The generation stage 402 is initiated upon a submission 410. The submission 410 may be based on an idea that defines, outlines, and/or consists of a design executable by AI models. The submission 410 may be assessed to determine if the submission 410 may be implemented into an AI model (e.g., practicality, parameterizable, value assessment). Further, the submission 410 may be compared to existing AI models in development and/or operation to determine if the submission 410 is similar to existing AI models. In some instances, the submission 410 may be flagged by the AI governance software tool as pre-existing or similar to existing AI models within the enterprise and request further consideration of AI model generation by the user. In other instances, the submission 410 may be approved for implementation into an AI model by the user (e.g., manager, team leader) of the AI governance software tool.

In some embodiments, the submission 410 is advanced to a demand creation stage 412 based on approval of the demand. The demand creation stage 412 of the generation stage 402 converts the submission 410 to a demand that may include various parametrized features (e.g., quantitative and/or qualitative features used as inputs within data sets), a priority level, a description, instructions for peer review, an AI model type, and other suitable information to instruct further development of the AI model. For example, formalization of the demand into an AI model may be conditioned upon access to a particular data set (e.g., stored in a database) for model training and/or implementation. As such, the demand creation stage 412 may prompt the user to input a file path of the particular data set to link the demand with training and/or implementation data needed for development. In certain embodiments, a demand progresses from the demand creation stage 412 to the development stage 404 of the AI governance software tool. The development stage 404 of the AI governance software tool may be based, for example, on industry standards for data mining. Briefly, a development cycle 414 may be implemented to provide transparency and governance of the AI model throughout the development stage 404. The development cycle 414 may include one or more stages that may be performed iteratively, randomly and/or in a particular sequence to develop the AI model. The one or more stages may include a business requirement evaluation stage 416, a data understanding stage 418, a data preparation stage 420, a modeling stage 422, an evaluation stage 424 (e.g., training validation, security and/or safety evaluation), and a deployment stage 426. It should be noted, that the AI model may be generated directly in the development stage 404.

In some embodiments, the business requirement evaluation stage 416 may include a value determination of the AI model actively being developed in the development cycle 414. The value determination may be based on an importance rank. The importance rank may be determined by correlating an ability of the AI model to streamline a workflow, avoid redundancies within the enterprise, incorporate user feedback, or a combination thereof. The value determination may be made for one AI model within the AI inventory record, a subset of AI models within the AI inventory record, and/or the AI inventory record in entirety. It should be noted, that additional factors may contribute to the importance rank used to determine the value determination.

In certain embodiments, the data understanding stage 418 and the data preparation stage 420 may be executed concurrently. For example, a plurality of features may be selected during the data preparation stage 420 for association with the AI models. The plurality of features may be selected based on elements outlined during the demand creation stage 412. The plurality of features may represent a measurable piece of data that can be used during implementation of the AI model. The plurality of features may be analyzed during the data understanding stage 418 (e.g., concurrently, before, and/or after execution of the data preparation stage 420) to develop an understanding of features of the AI model under development. As such, the plurality of features may be assigned a data quality value associated with an input of the AI model (e.g., data set, database, etc.). In certain embodiments, the data quality value associated with the input of the AI model may include a high-quality data and/or a low-quality data. The data quality value is associated with data demonstrated to be accurate, reliable, and appropriate data based on a calculated score. The calculated score may be based on a number of missing values, a percentage of missing values, a percentage of misaligned data, a number of unique values, and the like. For example, in some embodiments, the data quality value may be categorized as high-quality data when the calculated score is greater than 80 percent (e.g., the number of missing values is at least less than 20 percent). Further, in some instances, the data quality value may be categorized as high-quality data when the calculated score is greater than 90 percent (e.g., the percentage of missing values and/or misaligned data is at least less than 10 percent). In yet another embodiment, the data quality value may be categorized as low-quality data when the calculated score is less than 80 percent.

In certain embodiments, the input of the AI model may be used to train, build, and/or implement a goal of the AI model. A first threshold value of the data quality value may be determined during the development cycle 414 to develop a benchmark value that may be referred to during operation of the AI model. For example, the benchmark value may represent a ground truth value, and/or a value associated with high-quality data.

As such, the first threshold may be assigned as a value greater and/or less (e.g., 2 percent, 5 percent, 10 percent, 15 percent) than the benchmark value. For example, when the data quality value drifts outside the first threshold an alert may be generated (e.g., indicative of low-quality data). As such, when the AI model is operational a validity of an output of the AI model may be analyzed in comparison to the first threshold value associated with the input to the AI model. In this manner, the AI governance software tool may be approved for operation when the AI model satisfies the first threshold value. In this manner, during operation of the AI model when the first threshold value is met the AI model may not generate the alert to the user. In some instances, when the AI model is in operation and the first threshold value is not met, alerts may be sent to the user to indicate a change in the plurality of features used to generate one or more AI models of the AI inventory record.

In some embodiments, the data understanding stage 418 may also be used to determine a contribution level of particular features of the plurality of features associated with a particular AI model. The contribution level may indicate a relative contribution of the particular feature to the output of the particular AI model. In some instances, the contribution level is a weighted value based on a predictive power of a particular feature of the plurality of features. In this manner, the plurality of features may have various weights (e.g., weighted values, strength of nodes, values assigned to features) considered during AI model building, training, and/or implementation. As such, weighted values of the plurality of features used within the AI model impact the contribution level of the particular feature in the output of the AI model. In this manner, features with a higher weight (e.g., increased predicting power) may impact the output of the AI model to a greater extent (e.g., impact validity of outputs more than other features) increasing the contribution level of the particular feature within the particular AI model.

In some embodiments, the AI governance software tool may determine an importance rank of the particular feature related to an entirety and/or a portion of the AI inventory record (e.g., various AI models). The importance rank is based on a percentage or a weight that the particular feature contributes to one or more outputs of the AI inventory record (e.g., AI model) relative to other features of the plurality of features. In this way, the contribution level of each AI model may be used to determine the importance rank of the particular features in the AI inventory record. In some instances, the importance rank may be based on a priority calculation engine in which the contribution level of the plurality of features used in the AI inventory record is calculated. The priority calculation engine may rank the AI models of the AI record inventory into various percentiles based on the contribution level of the output being considered. For example, the percentiles may include a top 25 percent, a range from 50 percentile to 75 percentile, a 25 percentile to 50 percentile, a 0 percentile to 25 percentile of all AI models of the AI record inventory.

In some embodiments, one or more test cases may be generated during the modeling stage 422 of the development cycle 414. The one or more test cases may be automatically generated by the AI governance software tool to ensure the data selected in the data understanding stage 418 and the data preparation stage 420 meets elements outlined during the demand creation stage 412. The tests cases may also determine if the output of the AI model addresses the submission 410 that the AI model originated. As such, the tests cases may prompt the user to determine if the outputs of the AI model are in line with goals of the enterprise.

In certain embodiments, the evaluation stage 424 may be executed to determine a safety status of the AI model. The safety status of the AI model may be based on a privacy assessment and/or a security assessment of the AI model. For example, the privacy assessment may include meeting one or more compliance metrics (e.g., laws, policies, regulations). The one or more compliance metrics may ensure that the data used to train, build, and/or implement the AI model is from an open source and does not include data sets or databases marked as private, confidential, and/or otherwise tagged data. In some cases, the AI models may use private, confidential, and/or additional data to train, however, the evaluation stage 424 ensures that the output of the AI model does not include sensitive information (e.g., de-identification and/or anonymization of sensitive data) based on the data used for training. In some embodiments, the evaluation stage 424 may also execute a security assessment to define the safety status of the AI model. For example, the security assessment may include checks to ensure proper data management (e.g., storage consideration, data audit trail, version control, and so forth) throughout the AI model development workflow. With the foregoing stages of the development cycle 414 in mind, the AI governance software tool may execute a deployment stage 426. The deployment stage 426 may indicate that the AI model is no longer under development and may be implemented and/or marked as operational in the enterprise.

In certain embodiments, the implementation stage 406 is executed after the deployment stage 426. It should be noted, that this is one, non-limiting example of an order of stages of the AI governance software tool and any suitable order of stages is considered. As shown in the illustrated embodiment, the AI models of the AI inventory record usage may be deployed and tracked by the AI governance software tool during an operationalization stage 428. Various actions may be taken to implement, leverage and/or streamline AI model usage during the operationalization stage 428. For example, the operationalization stage 428 may define various AI artifacts (e.g., machine learning artifacts) such as outputs, data, knowledge, trained model, checkpoints, benchmarks, algorithms, files, and the like. The AI artifacts may be generated during execution of the AI model of the AI inventory record. Generating definitions of machine learning artifacts may allow for streamlined incorporation of outputs from the AI model into various workflows within the enterprise. For example, a particular AI model (e.g., fraud detection) may generate an output corresponding to a change in usage patterns. The output may be defined based on variance from a known pattern. In this manner, the defined output may be directly incorporated into subsequent processes (e.g., fraud alerts) based on the output of the particular AI model.

In certain embodiments, the management stage 408 is implemented within the AI governance software tool as a monitoring stage 430. The management stage 408 may be implemented at any suitable stage within the AI governance software tool. For example, the management stage 408 may actively monitor (e.g., the monitoring stage 430) the AI models during the development cycle 414. The monitoring stage 430 may analyze (e.g., assess, observe) a data quality value (e.g., input of the AI model), a risk score, a usage frequency, a lifecycle, a value assessment, and/or an availability (e.g., processing power, data management levels) of the AI models within the AI governance software tool. For example, the value assessment of the AI model may be analyzed during the monitoring stage 430 to determine an impact (e.g., efficiency, usage, rank, user feedback) of the AI model within the AI governance software tool.

Further, in some embodiments, the management stage 408 may analyze the risk score associated with AI models based on the data quality value, a feature importance (e.g., the features of the model trained and/or tested by data sets), and/or a number of AI models impacted by a change within the AI inventory record. In this manner, the risk score may indicate to the user the risk associated with continued implementation of a particular AI model and/or related AI models within the AI governance software tool. For example, the data quality value of a particular data set may be analyzed during the monitoring stage 430 and assessed to be of low-quality data, where low-quality data is defined as below a threshold value where the threshold value may be based on the calculated score, an accuracy, a completeness, a relevance, a consistency, or a combination thereof of the particular data set. For example, in some instances, the threshold value may be below the calculated score (e.g., 80 percent, 90 percent, etc.) of the data quality value based on the number of missing values, the percentage of missing values, the percentage of misaligned data, the number of unique values, and the like. As such, the management stage 408 may alert the user to the data quality value of the particular data set and provide an alert with an importance level determined by the risk score of the particular data set. The user may act to remove, recover, and/or edit the particular data set to ensure the particular data set may not impact AI models used within the enterprise. It may be advantageous for the alerts of the AI governance software tool to be displayed on a user interface to provide centralized feedback to the organizational users via a dashboard.

In some embodiments, the management stage 408 of the AI governance software tool may be used to provide a single platform to streamline and track AI models throughout implementation, version control, and retirement of models. In this manner, the AI governance software tool provides centralized feedback to the users via the single platform. Further, the management stage 408 creates transparency within the enterprise as correction and/or removal of features and/or inputs used to train and/or implement the AI models based on assessment of alerts generated by the AI governance software tool and/or additional assessments may be indicated across workflows. For example, data sets used as inputs in training of the AI models may be changed by the user (e.g., edited, updated, removed) by users once alerted by the AI governance software tool to bring the AI model back to compliance. The management stage 408 may determine if one or more outputs of additional AI models within the AI inventory record may be impacted by changes made by the user. In this manner, the management stage 408 outputs and/or transmits an alert and/or a notification to one or more respective profiles associated with the AI models that may flag the AI model and/or the additional AI models. In this manner, all AI models impacted by user executed changes may be updated during the management stage 408 to ensure the additional AI models maintain reliability of other AI models. In some cases, the additional AI models may be flagged to ensure all users within the enterprise are aware of executed changes.

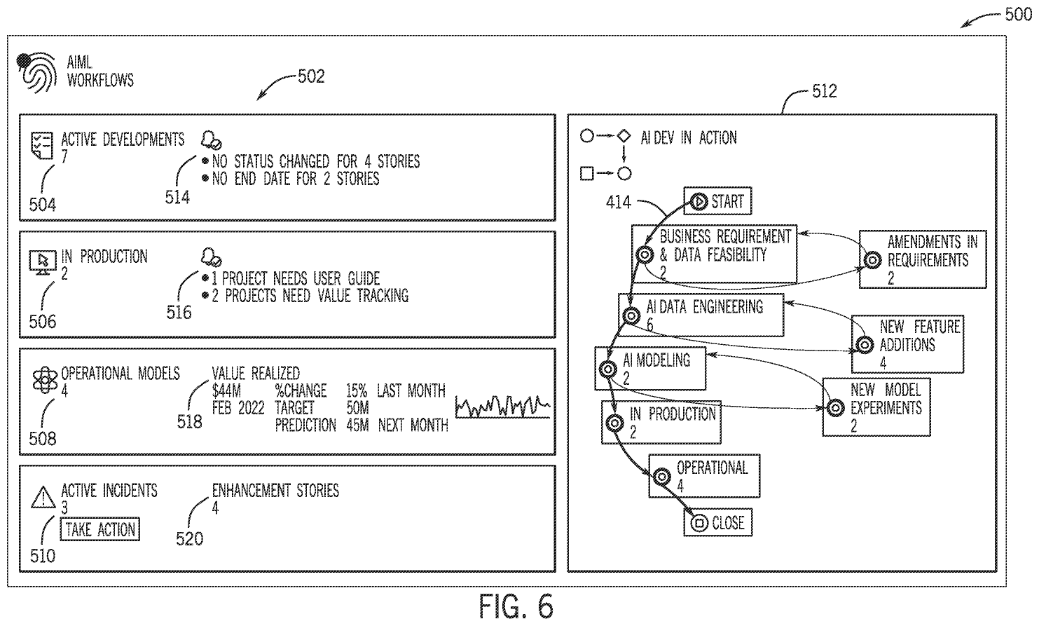

With the preceding in mind, FIG. 6 is a schematic embodiment of a user interface 500 of the AI governance software tool. The user interface 500 may display a screen having a dashboard 502 (e.g., command center) that may be used to streamline and track AI model generation, development, operationalization, management, and retirement of the AI models of the AI governance software tool. In this manner, the AI governance software tool provides centralized feedback to the users via the dashboard 502. The dashboard 502 may include various widgets (e.g., user interface widgets) providing alerts, notifications, status updates, user requests, value assessments and the like. Further, the AI governance software tool creates transparency throughout the informational flow across the enterprise by providing PaaS technologies to enhance execution of AI models.

In some embodiments, the various widgets of the dashboard 502 include one or more of a development widget 504, an implementation widget 506, an operationalization widget 508, an alerts widget 510, and a development process widget 512. The development widget 504 may display a plurality of status updates 514. Each status update 514 may include notifications indicative of a change in status, a unique identifier, missing parts (e.g., end date, deployment data, description, etc.) for a particular AI model within the AI inventory record. For example, the change in status of the particular AI model may be displayed to the user on the dashboard 502 indicating that a submission was approved and demand creation was initiated through a story creation process. It should be recognized that the development widget 504 may include additional information related to active development of AI models.

The implementation widget 506 may provide a plurality of user requests 516 related to AI model (e.g., project) deployment. For example, the user requests 516 may include a request for creation of a user guide (e.g., standard operation procedure) to facilitate usage of the AI models within the enterprise. Additionally, the user requests 516 may include prompts for the user to quantify potential value of a particular AI model. The user requests 516 may include additional options that may enable the user to dynamically adjust implementation of the AI models within the AI governance software tool. In some embodiments, the implementation widget 506 may display progress of development and/or deployment of a plurality of concurrently running AI models. The operationalization widget 508 may display one or more quantitative and/or qualitative metrics 518 of the AI models in operation. The metrics 518 may include an execution efficiency, a target goal (e.g., value goal), a target prediction (e.g., value prediction), or a combination thereof. For example, a rank associated with the AI models of the AI inventory record may be tracked throughout a period of time. The rank associated with the AI models may be based on usage of the AI model across the enterprise, impact to an output of the AI models to subsequent processes of the enterprise, and/or user interaction of the AI models.

In some embodiments, the alerts widget 510 may display a plurality of alerts 520 associated with one or more AI models of the AI governance software tool. The alerts 520 may include an index indicative of a level of urgency/importance of a particular alert. For example, the alerts 520 may be listed and/or sorted with various degrees of urgency related to the risk score used to generate the alert. For example, the alert could include an incident, a defect, and/or a request based on one or more threshold values associated with the risk score. It should be recognized that the alerts widget 510 may include additional information related to AI models of the AI inventory record such as risk scores (e.g., additional risk scores), importance ranks, contribution levels, data quality, workflow incorporation, prioritization or the like. In some instances, the user interface including the plurality of widgets may display alerts as a notification to the user on one or more respective profiles related to the determined risk impact, the determined importance rank, the determined risk score, and the like.

In certain embodiments, the development process widget 512 may display active tracking of the development cycle 414 as described above in reference to FIG. 5. For example, the development cycle 414 may display quantitative tracking of various AI models within the development cycle 414 to provide the user with active insight to a number of AI models being developed across the enterprise. In this manner, productivity and workflow management may be readably accessed by the user generating transparency and accountability throughout portfolios of AI models within the enterprise.

It should be recognized that while the illustrated embodiment shows the dashboard 502 including the development widget 504, the implementation widget 506, the operationalization widget 508, the alerts widget 510, and the development process widget 512 on the same screen, the dashboard 502 may display each of these widgets on separate screens within the user interface 500 and/or may allow a user to select which widgets will be shown, the placement of such widgets, and so forth. Additionally, in certain embodiments one or more conditions or rules may be created or parameterized by a user to control when and/or where a widget is displayed, such as prompting display or updating of a widget in response to updated data monitored by the widget (e.g., display of a widget or placement of the widget may be updated in response the data conveyed by the widget changing or being updated). Additionally or alternatively, the screen via the dashboard 502, may display any combination of the development widget 504, the implementation widget 506, the operationalization widget 508, the alerts widget 510, and the development process widget 512.

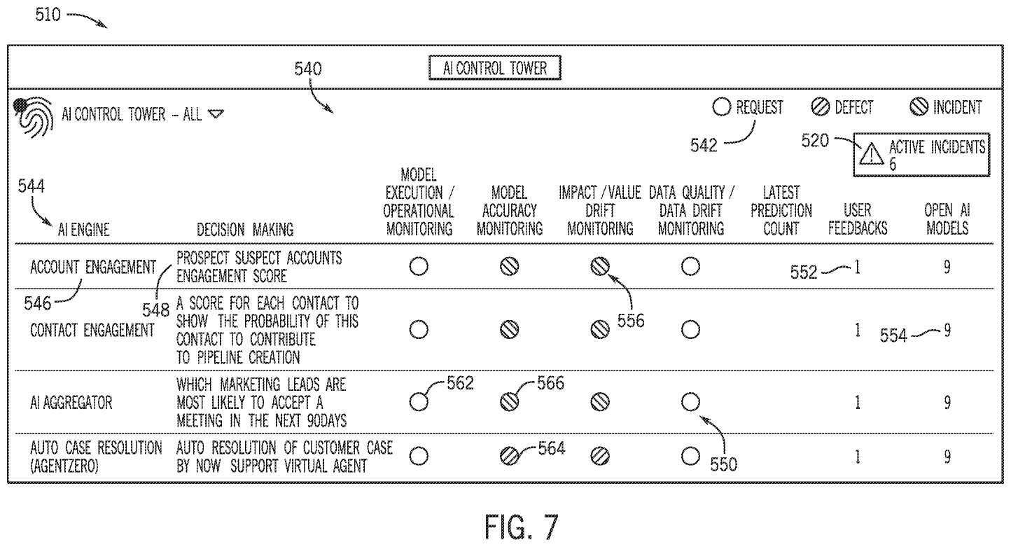

Referring now to FIG. 7, the AI governance software tool may display the alerts widget 510 having the alerts 520 (e.g., notifications) on a screen 540 of the user interface. As shown, the alerts widget 510 may include a key 542 (e.g., alert identifier) and an alert table 544. The alert table 544 may include an AI engine identifier 546, the alert description 548, a plurality of alert statuses 550 (e.g., execution status, accuracy, impact, value, drift monitoring, data quality monitoring, etc.), a count of user feedback inputs 552, a count of associated AI models 554, and/or a combination thereof. Further, the plurality of alert status 550 displayed on the screen 540 may be one or more alert buttons 556 within the alert table 544. The alert buttons 556 may generate a resolve button, an archive button, an unarchive button when selected by the user within the user interface. The alert buttons may allow the user to resolve, archive, unarchive, check statuses of AI models within the AI inventory record.

In some embodiments, the AI governance software tool may, during the management stage, determine the data quality value associated with an input of the AI model to provide alerts based on changes to the risk score associated with the data quality value used to build, train, and/or implement the AI model. The alert table 544 may include the alert statuses 550 using the key 542 to indicate the importance level determined by the risk score of the particular data set associated with the alert. The importance level (e.g., type of alert) of the alert displayed on the screen 540 may include a request 562, a defect 564, and/or an incident 566 based on one or more threshold values associated with the risk score. The risk score associated with particular features of the AI model may be determined based on the contribution level of the particular levels to the output of the AI model. For example, when the risk score of the AI model satisfies a second threshold value the priority of the alert may be indicated as the request 562. In some embodiments, the risk score of the AI model may satisfy a third threshold indicative of the importance level of the defect 564. In other embodiments, the risk score may satisfy a fourth threshold indicative of the incident 566. The request 562 may indicate to the user on the user interface that one or more of the AI models are affected by the particular feature.

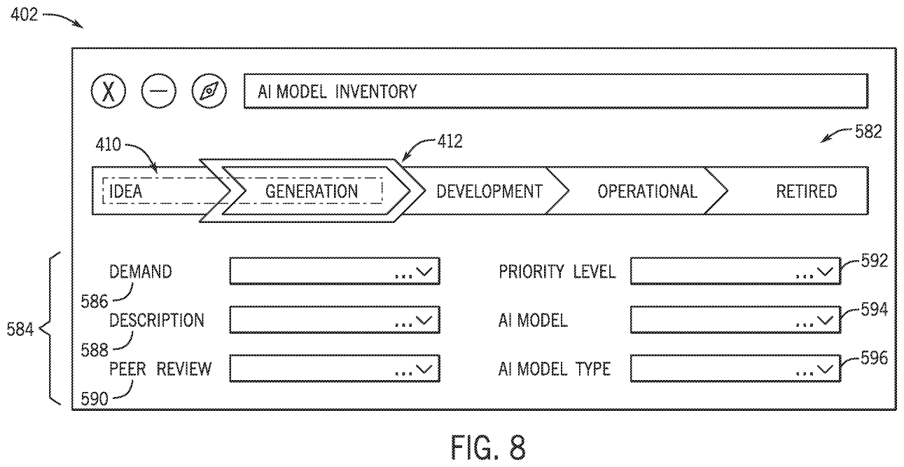

Referring now to FIG. 8, a schematic embodiment of the user interface of the generation stage 402 of the AI governance software tool is depicted as displayed on a screen 582. As shown, the generation stage 402 may display the screen 582 during the demand creation stage 412 as outlined in reference to FIG. 5. The user interface may allow the user to select, view, and/or manage one or more applications 584 deployed by the generation stage 402. The various applications 584 may include a demand field 586 that may include various parametrized features (e.g., quantitative and/or qualitative features used as inputs within data sets), a description field 588, a peer review field 590, a priority field 592, an AI model field 594, an AI model type field 596 and other suitable information to instruct further development of the AI model. The applications 584 represent applications that may be edited and/or modified by the user, as described in greater detail below.

For example, the demand field 586 may allow the user to identify the submission 410 used to generate the demand within the generation stage 402. As such, the demand field 586 may prompt the user to input a file path of a particular data set to link the demand with training and/or implementation data needed for development. The description field 588 may provide information associated with tasks a respective demand may be expected to perform when developed into an AI model, services provided by the respective demand, and the like. For example, the description field 588 may allow the user to input a summary of goals of the AI model. The summary may allow additional users of the enterprise to determine if the AI model based off a particular demand may be of use in additional contexts without need of additional submission and demand creations stages. In this manner, the description field 588 may create transparency throughout workflows of the enterprise to streamline AI model generation, implementation and usage.

The peer review field 590 may provide selection of suitable profiles (e.g., corresponding to users) within the enterprise to assess the demand. For example, formalization of the submission 410 to the demand may utilize various parametrized features. As such, the parametrized features may be conditioned upon assessment by the selected profiles to ensure formalization of the submission into the demand retains value offered by the submission. As such, in some embodiments, the demand may be conditioned approval by the selected profile(s) before progressing to the development stage 404. The priority field 592 may allow the user to assign a priority to the demand. In some embodiments, the priority assigned to the demand may be used in subsequent stages of the AI governance software tool. For example, the priority may be used to assess the importance rank of the AI model during the monitoring stage of the framework of the AI governance software tool. As such, the priority may be used by the priority calculation engine to provide context of value of the AI model within the workflow of the enterprise.

In certain embodiments, the AI model field 594 and the AI model type field 596 may be selected by the user and may be indicative of a particular type of AI model that may be used within the development stage 404. For example, the AI model field 594 may indicate a particular AI model used within the enterprise that may be suitable to execute the demand. The particular AI model may be selected to indicate that existing AI models within the enterprise may be suitable with modification to execute the demand. In some instances, the AI model field 594 may allow the user to indicate a type of AI model that may be developed to execute the demand. The AI model type field 596 may be used to select appropriate AI model techniques (e.g., neural networks, machine learning, decision tree, regression tree, natural language processing, random forest, and the like).

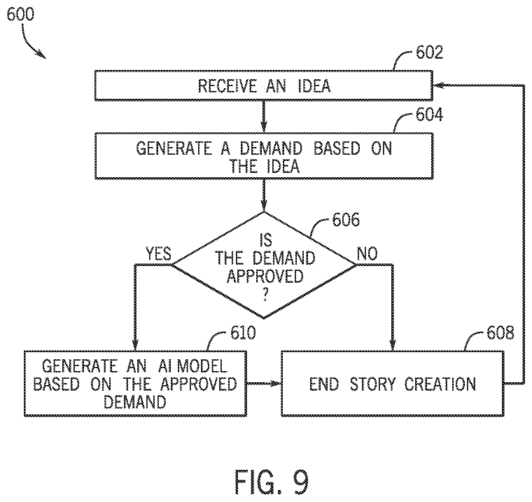

Referring now to FIG. 9 the AI governance software tool may perform a process 600 for generating a demand. The process 600 may be performed by a computing device or controller disclosed above with reference to FIG. 1 or any other suitable computing device(s) or controller(s). Furthermore, the blocks of the process 600 may be performed in the order disclosed herein or in any suitable order. For example, certain blocks of the process may be performed concurrently. In addition, in certain embodiments, at least one of the blocks of the process 600 may be omitted.

At block 602 of the process 600, the submission may be received from an input and/or an additional input of the user interface, an additional user interface, and/or a database associated with the AI governance software tool such as the user interface of the generation stage of the AI governance software tool as discussed in reference to FIG. 8. In some embodiments, the submission received from the input may include ideas relating to AI automation, AI integration, AI guidance (e.g., chatbots, automated helpdesks, natural language processing), organization, data management, and the like. For example, automation of routine and/or repetitive tasks may be proposed as the submission to reduce burdens on the users of the enterprise. At block 604 of the process 600, a demand may be generated based on the submission. The demand may include one or more parameters that relate to data sets needed for implementation, parameters of expected outputs, and the like. It should be recognized that the demand may include additional information related to the enterprise and/or the submission.

At block 606 of the process 600, a status of the demand is determined based on inputs of the user interface, peer review, evaluation of redundancies, and the like. The demand may be approved, denied, or postponed for progression into the development stage based on the status of the demand. In certain embodiments, the status of the demand is updated based on selections that may be input into the user interface (e.g., by the user). In some embodiments, the status of the demand is determined via the processor based on predetermined metrics (e.g., similarity to existing AI models, processing power available for development of additional AI models). If the demand is not approved at block 606, the process 600 may proceed to end demand creation (e.g., story creation) at block 608. In some embodiments, the process 600 may return to block 602 after block 608 (e.g., receive additional submissions) and the process 600 may iteratively proceed through the above outlined blocks (e.g., blocks 602 through 606) handling one or more submissions received as inputs (e.g., user inputs). If the process 600 receives approval of the demand at block 606, the AI governance software tool may proceed to block 610 of the process 600. At block 610, generation of the AI model (e.g., a new AI model) based on the approved demand may initiate the development cycle as described above in relation to FIG. 5. In some instances, additional blocks may be executed at block 610 including, for example, the evaluation stage (e.g., training validation, security and/or safety evaluation). The process 600, may proceed to block 608 to end story creation. It should be noted, that the AI governance software tool may iteratively perform the blocks outlined in process 600, receiving various submissions and generating demands that upon approval may be progressed to the development cycle of various AI models.

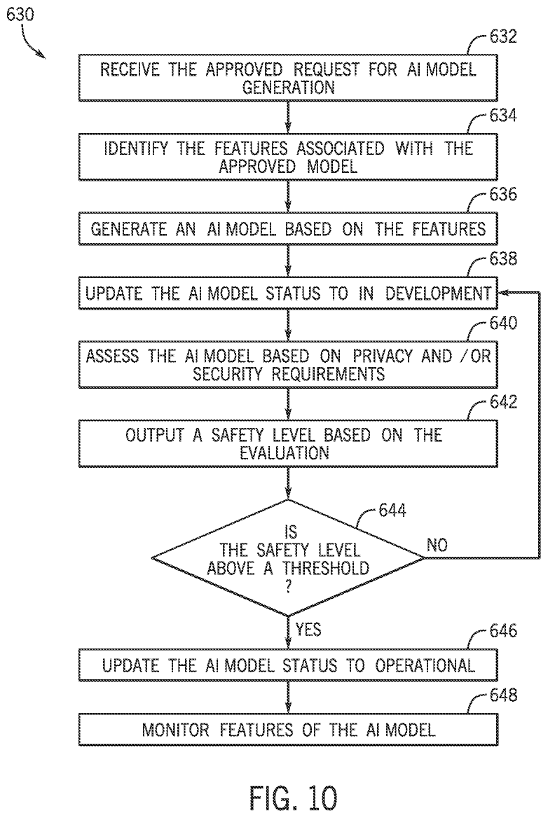

Referring now to FIG. 10, the AI governance software tool may perform a process 630 for evaluating a security assessment and/or safety assessment during the development cycle of the AI models. The process 630 may be performed by a computing device or controller disclosed above with reference to FIG. 1 or any other suitable computing device(s) or controller(s). Furthermore, the blocks of the process 630 may be performed in the order disclosed herein or in any suitable order. For example, certain blocks of the process may be performed concurrently. In addition, in certain embodiments, at least one of the blocks of the process 630 may be omitted.

At block 632 of the process 630, the AI governance software tool receives an approved request for generation of the AI model, as discussed in reference to the process of FIG. 9. It should be noted, in some instances, the approved request for generation of the AI model may be directly executed within the security and/or safety evaluation of process 630 without need of execution of process 600. At block 634, the AI governance software tool may identify the plurality of features associated with the approved model. The plurality of features associated with the approved model may represent a measurable piece of data that can be used during implementation of the AI model. At block 636, an AI model may be generated by the AI governance software tool based on the features. Upon AI model generation, at block 638, a status of the AI model may be marked as in development. Where “in development” may include one or more blocks of the development stage of the AI governance software tool.

At block 640, the AI governance software tool may assess the AI model based on one or more privacy guidelines and/or security guidelines. The privacy assessment may include meeting one or more compliance metrics (e.g., laws, policies, regulations). The security assessment may include checks to ensure proper data management (e.g., storage consideration, data audit trail, version control) throughout the AI model development workflow. It should be noted that assessment of the privacy guidelines and the security guidelines may be executed alone or in combination with each other during block 640 of the process 630.

At block 642, the process 630 may output a privacy report and/or a security level based on the evaluation of the AI model. The safety level may be based on the privacy guidelines and/or the security guidelines. In some instances, the safety level is a quantitative value representative of an associated risk informed by the privacy assessment, security assessment, or a combination thereof. The associate risk may be calculated by the AI governance software tool based on the compliance metrics and data management checks of the AI model. At block 644, the AI governance software tool determines if the safety level is above a threshold (or more generally has crossed or passed a threshold of interest by either exceeding or falling below the threshold). The threshold may be based on a benchmark safety level indicative of acceptable associated risk (e.g., determined by the enterprise). In some embodiments, at block 644, the safety level is determined by the AI governance software tool to be below the threshold. The process 630 returns to block 638 retaining the AI model in the development stage and executing block 640 through block 644 iteratively until the safety level is determined to be above the threshold. It should be noted, that the AI governance software tool may establish a protocol for the safety level failing to meet the threshold after a certain amount of iterations (e.g., 2, 5, 10, 15, 20) of process 630. For example, the process 630 may terminate iterative evaluation of the AI model and output an alert to the user indicative of failing the safety level.

In some embodiments, the safety level is above the threshold and the process 630 proceeds to block 646 to update the AI model status to operational. Wherein “operational” may indicate that the AI model may be implemented within existing, new, and/or any suitable process within workflows of the enterprise. It should be noted, that while process 630 outlines evaluating the security and/or safety of the AI model during the development cycle to achieve operational status that one or more additional evaluations may be made by the AI governance software tool before, after, and/or concurrently with the security and/or safety evaluation stipulating progression of the AI model to operational. At block 648, the AI governance software tool monitors features of the AI model. Block 648 may be executed as part of the monitoring stage of the AI governance software tool framework.

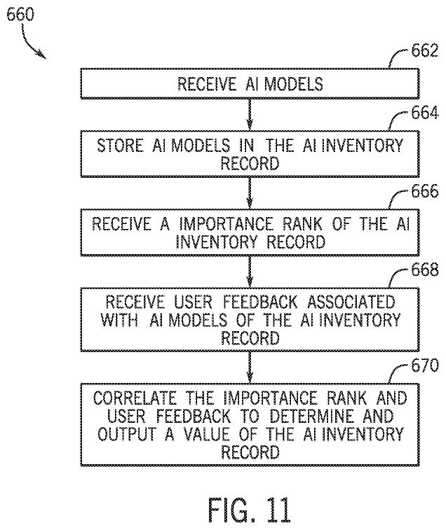

Referring now to FIG. 11, the AI governance software tool may perform a process 660 executing a value determination of the AI inventory record. The value determination may be performed as part of the business requirement evaluation stage of the development stage of the AI governance software tool framework. The process 660 may be performed by a computing device or controller disclosed above with reference to FIG. 1 or any other suitable computing device(s) or controller(s). Furthermore, the blocks of the process 660 may be performed in the order disclosed herein or in any suitable order. For example, certain blocks of the process 660 may be performed concurrently. In addition, in certain embodiments, at least one of the blocks of the process 660 may be omitted.

At block 662 of the process 660, the AI governance software tool receives the AI models. The AI models may be compiled from various workflows of the enterprise, collected from various stages of the AI governance software tool, and/or directly input by the user. At block 664, the AI governance software tool stores the AI models in an AI inventory record. The AI inventory record may include all AI models of the enterprise, a portion of the AI models, or any suitable amount of AI models. Storing the AI models in the AI inventory record may provide centralization and streamlining of processes within the enterprise relating to the management of AI models. At block 666, the AI governance software tool receives an importance rank of the AI models of the AI inventory record. The importance rank may indicate ability of the AI models within the AI inventory record to streamline processes (e.g., eliminate redundancies, eliminate repetitive and/or unnecessary steps, automate tasks, and the like). In some embodiments, the contribution level of each AI model may be used to determine the importance rank of the AI models and/or particular features of the AI models in the AI inventory record. In some instances, the importance rank may be based on the priority calculation engine in which the contribution level of the plurality of features used in the AI inventory record is calculated.

At block 668, the process 660, may also receive user feedback data associated with the AI models of the AI inventory record. The user feedback data may be collected internally (e.g., employees) and/or externally (e.g., customers) to the enterprise. In some instances, the user feedback data may indicate how often AI models within the AI inventory are executed, user interactions with the AI models, response of prompted feedback requests by the AI governance software tool to users, and the like. At block 670, the AI governance software tool may correlate the importance rank and the user feedback to determine and output a value of the inventory record. The value of the inventory record may be provided to the user via an alert and/or a notification during the business requirement evaluation stage of the development stage of the AI governance software tool framework.

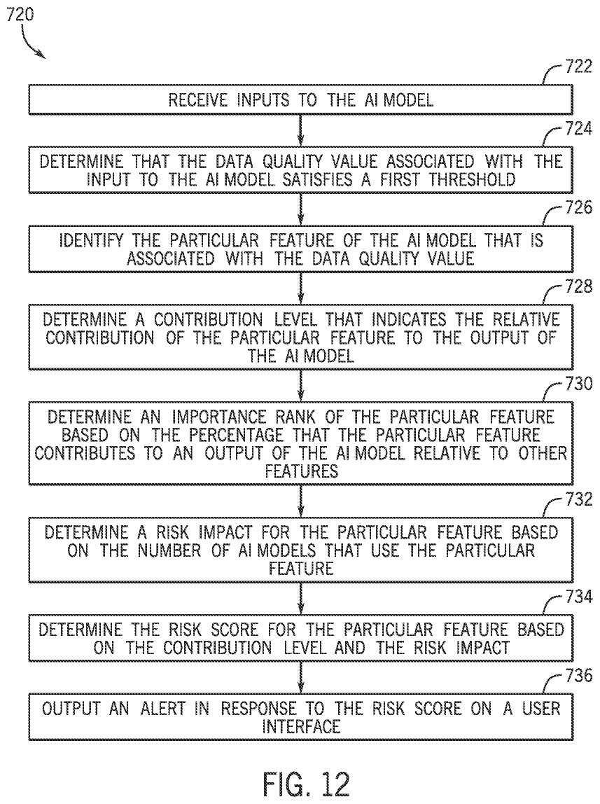

Referring now to FIG. 12, the AI governance software tool may perform a process 720 for monitoring a data quality value of the AI models of the AI inventory record to provide alerts based on a risk score of the data quality value. The process 720 may be performed by a computing device or controller disclosed above with reference to FIG. 1 or any other suitable computing device(s) or controller(s). Furthermore, the blocks of the process 720 may be performed in the order disclosed herein or in any suitable order. For example, certain blocks of the process may be performed concurrently. In addition, in certain embodiments, at least one of the blocks of the process 720 may be omitted.

At block 722 of the process 720, the AI governance software tool receives inputs used as inputs to the AI model. The inputs may include a particular data set (e.g., stored in a database) used to train and/or implement the AI model, the plurality of features associated with the AI model, and/or the importance rank associated with the AI model. At block 724, the AI governance software tool determines if a data quality value associated with the input of the AI model satisfies a first threshold. The first threshold value may be determined during the development cycle of the AI model. In general, the first threshold may be based on the calculated score associated with the data quality value. The calculated score may categorize the data quality value associated with the input of the AI model as high-quality data and/or low-quality data. The calculated score may be based on a number of missing values, a percentage of missing values, a percentage of misaligned data, a number of unique values, and the like. For example, in some instances, the data quality value may be categorized as high-quality data when the calculated score is greater than 80 and as low-quality data when the calculated score is less than 80 percent. If the data quality value satisfies the first threshold (e.g., above a certain value of the calculated score) the process 720 proceeds to block 726. In some instances, when the data quality value does not satisfy the first threshold (e.g., below the certain value of the calculated score) the process 720 may end. For example, the process 720 may end when the first threshold is not satisfied corresponding to the calculated score of less than 80 percent. Further, in some instances, when the process 720 is terminated the data quality values may be stored for future inspection by the user. At block 726 the process 720, identifies a particular feature of the AI model that is associated with the data quality value determined in block 724. At block 728, the AI governance software tool determines a contribution level that indicates a relative contribution of the particular features to an output of the AI model. The relative contribution of the particular features may be based on a weight, a predicting power, and/or a contribution level of the particular feature within the AI model.

At block 730, the AI governance software tool determines the importance rank of the particular feature based on a percentage that the particular feature contributes to the output of the AI model relative to other features of the plurality of features. For example, features associated with higher predicating powers (e.g., above a predetermined threshold) may be weighted with greater significance in determining the output of the AI model. In this manner, features with higher predicting power may impact the importance rank relative to features with lower predicting power (e.g., below the predetermined threshold). At block 732, the AI governance software tool determines a risk impact for the particular feature based on a number of AI models of the AI inventory record that use the particular feature. Further, the risk impact may be based on a percentile of AI models of the AI inventory using the particular feature. For example, the risk impact may be assigned a value (e.g., value of 1, 2, 3, or 4) based on the percentile of AI models using the particular feature in the enterprise. A value of 4 associated with a highest risk impact may be assigned to the particular feature used in a top 25 percentile. Further, a value of 3 may be assigned to the particular feature used in the percentile ranging from 50 to 75. A value of 2 may be assigned to the particular feature used in the percentile ranging from 25 to 50. A value of 1 may be assigned to the particular feature used in the percentile ranging from 0 to 25. In this manner, the user may be able to assess the relevancy of the particular feature across the enterprise based on the assigned value of the risk impact.

At block 734, the AI governance software tool determines a risk score for the particular feature based on the contribution level and/or the risk impact. In some embodiments, the risk score may be determined by calculating a logarithm of base 10 of the product of a value of the contribution level and a value of the risk impact. In this manner, the risk score may depend on a priority and/or an impact of the particular feature. Further, in some instances, the risk score may be associated with a risk level. The risk level may be a very high risk (e.g., risk scores greater than 10). In other instances, the risk score may be associated with the risk level including a high risk (e.g., risk scores greater than 5). In yet other instances, the risk score may be associated with a low risk (e.g., risk scores less than 5).

At block 736, the AI governance software tool outputs an alert in response to the risk score satisfying a second threshold value. The second threshold may be based on the risk level of the risk score (e.g., greater than 10, greater than 5, and the like). In some instances, the second threshold value may be satisfied when the risk level of the risk score is greater than 10. When the second threshold value is satisfied, the alert is output to an external platform (e.g., command center, dashboard) for display via the user interface. The alert identifies one or more AI models affected by the particular feature. Accordingly, the alert may be used to notify other components using the particular feature that the feature may be experiencing an anomaly. As such, the AI governance software tool and/or the user (e.g., alerted by the monitoring stage) may ensure that outputs of the AI models affected by the particular feature are flagged, decommissioned, more closely monitored, double checked, and/or any suitable action to ensure users within the enterprise are made aware of possible output variations. The AI governance software tool may provide centralized and/or streamlined management of AI models within the AI inventory record that may be overlooked in decentralized management frameworks. It should be noted, that the process 720 may be executed with fewer blocks, for example, block 732 may be omitted from the process 720.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method comprising:
determining that a data quality value associated with an input to an artificial intelligence (AI) model satisfies a first threshold value, wherein the AI model is characterized by a plurality of features;
identifying a particular feature of the plurality of features that is associated with the data quality value;
determining a contribution level that indicates a relative contribution of the particular feature to an output of the AI model;
determining a risk score for the particular feature based on the contribution level; and
outputting an alert in response to the risk score satisfying a second threshold value, wherein outputting the alert comprises outputting the alert to an external platform for display via a user interface, wherein the alert identifies one or more AI models affected by the particular feature.

2. The method of claim 1, comprising:
determining an importance rank of the particular feature, wherein the importance rank is based on a percentage that the particular feature contributes to an output of the AI model relative to other features of the plurality of features.

3. The method of claim 2, comprising:
determining a risk impact for the particular feature, wherein the risk impact is based on a number of AI models, including the AI model, that use the particular feature.

4. The method of claim 3, wherein the user interface comprises a plurality of user interface widgets configured to display the determined risk impact, the determined importance rank, the determined risk score, or a combination thereof.

5. The method of claim 1, wherein the alert comprises an incident, and wherein the risk score is greater than the second threshold value, a third threshold value, and a fourth threshold value.

6. The method of claim 1, wherein the alert comprises a defect, and wherein the risk score is greater than the second threshold value and a third threshold value, but less than a fourth threshold value.

7. The method of claim 1, wherein the alert comprises a request, and wherein the risk score is greater than the second threshold value, but less than a third threshold value and a fourth threshold value.

8. The method of claim 1, wherein outputting the alert comprise generating and transmitting a notification to one or more respective profiles associated with the AI models that use the particular feature.

9. The method of claim 1, wherein determining that the data quality value for the input to the AI model is below the first threshold value is performed automatically by monitoring the data quality value.

10. The method of claim 1, wherein determining that the data quality value for the input to the AI model is below the first threshold value is based on an input received from the user interface.

11. A system, comprising:
processing circuitry; and
memory, accessible by the processing circuitry, the memory storing instructions that, when executed by the processing circuitry, cause the processing circuitry to perform operations comprising:
determining that a data quality value associated with an input to an artificial intelligence (AI) model satisfies a first threshold value, wherein the AI model is characterized by a plurality of features;
identifying a particular feature of the plurality of features that is associated with the data quality value;
determining a contribution level that indicates a relative contribution of the particular feature to an output of the AI model;
determining an importance rank of the particular feature, wherein the importance rank is based on a percentage that the particular feature contributes to an output of the AI model relative to other features of the plurality of features;
determining a risk impact for the particular feature, wherein the risk impact is a number of AI models, including the AI model, that use the particular feature;
determining a risk score for the particular feature based on the risk impact and the contribution level; and
outputting an alert in response to the risk score satisfying a second threshold value, wherein outputting the alert comprises outputting the alert to an external platform for display via a user interface, wherein the alert identifies one or more models affected by the particular feature.

12. The system of claim 11, wherein the alert comprises an incident, and wherein the risk score is greater than the second threshold value, a third threshold value, and a fourth threshold value.

13. The system of claim 11, wherein the determining that the data quality value for the input to the AI model is below the first threshold value is based on an input received from the user interface.

14. The system of claim 11, wherein the contribution level is a weighted value based on a predictive power of the particular feature.

15. The system of claim 11, wherein the processing circuitry performs operations comprising:
receiving a submission for a new AI model, wherein the submission is based on an additional input received from the user interface or an additional user interface;
generating a demand for the new AI model, wherein the demand is based on the submission for the new AI model;
receiving an approval of the demand for the new AI model; and
generating, in response to receiving the approval of the demand for the new AI model, the new AI model.

16. The system of claim 11, wherein the processing circuitry performs operations comprising:
assessing the AI model based on one or more privacy guidelines and/or safety guidelines;
outputting a safety level of the AI model based on the assessment; and
determining that the safety level is below a fourth threshold; and
outputting, in response to the safety level of the AI model being below the fourth threshold, an additional alert indicating that the safety level of the AI model is below the fourth threshold.

17. A non-transitory computer-readable storage medium, comprising processor-executable routines that, when executed by a processor, cause the processor to perform operations comprising:
determining that a data quality value associated with an input to an artificial intelligence (AI) model satisfies a first threshold value, wherein the AI model is characterized by a plurality of features;
identifying a particular feature of the plurality of features that is associated with the data quality value;
determining a contribution level that indicates a relative contribution of the particular feature to an output of the AI model;
determining a risk impact for the particular feature, wherein the risk impact is based on a number of AI models, including the AI model, that use the particular feature;
determining a risk score for the particular feature based on the risk impact and the contribution level; and
outputting an alert in response to the risk score satisfying a second threshold value, wherein outputting the alert comprises outputting the alert to an external platform for display via a user interface, wherein the alert identifies one or more models affected by the particular feature.

18. The non-transitory computer-readable storage medium of claim 17, wherein the processor performs operations comprising:
receiving a submission for a new AI model, wherein the submission is based on an additional input received from the user interface or an additional user interface;
generating a demand for the new AI model, wherein the demand is based on the submission for the new AI model;
receiving an approval of the demand for the new AI model; and
generating, in response to receiving the approval of the demand for the new AI model, the new AI model.

19. The non-transitory computer-readable storage medium of claim 17, wherein the processor performs operations comprising:
determining an importance rank of the particular feature, wherein the importance rank is based on a percentage that the particular feature contributes to an output of the AI model relative to other features of the plurality of features.

20. The non-transitory computer-readable storage medium of claim 17, wherein the risk score is indicative of a risk associated with continued implementation of a particular AI model of a plurality of AI models.
